(19) United States
(12) Patent Application Publication
(10) Pub. No.: US 2010/0176070 A1
(43) Pub. Date: Jul. 15, 2010

(54) FILTER RENEWAL SYSTEM AND A METHOD THEREOF

(76) Inventor: Hee Juan HAN, Singapore (SG)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/440,411

(22) PCT Filed: Aug. 15, 2007
(86) PCT No.: PCT/SG2007/000256

§ 371 Date: Mar. 6, 2009

(30) Foreign Application Priority Data
Sep. 8, 2006 (SG) 200606061-0

(51) Int. Cl. B01D 29/66

(52) U.S. Cl. 210/798; 210/797; 210/409; 210/151; 210/411

(57) ABSTRACT

An apparatus and a method of rejuvenating capillary filters (2) using both gas agitation of the liquid about the surface of capillary filters (2) and backflushing the capillary filters (2) is disclosed. The gas agitation loosens residue on the surface of the capillary filters (2) and the backflush further loosens residue in an inside-out direction through the walls of capillary filters (2). The agitation of the liquid aids in dispersion, suspensions and transportation of the releases residue form the capillary filters (2).

### FIELD OF THE INVENTION

The present invention relates to the field of filters and particularly to hollow fibre filters or capillary filters.

### BACKGROUND

A strand of capillary filter used for fine filtering a liquid such as water, is formed typically, from a hollow tube having a permeable membrane wall. The capillary filter is used submerged in the liquid to be filtered. The liquid flows across the membrane wall, usually under a ‘trans-membrane-pressure’, from outside the capillary filter into the hollow channel inside the capillary filter. Particles in the liquid are unable to permeate the membrane wall and are left outside the capillary filter as residue. Thus, the liquid filtered by the permeation flows in the hollow channel in the capillary filter to a collection point.

Over time, residue eventually accumulates on the external surface of the capillary filter, clogging the membrane wall and compromising filter performance. One solution to the problem of clogged capillary filters is to replace them. However, this is uneconomic.

Another solution is to rejuvenate or renew capillary filters by backflushing a flow of liquid into the hollow of the capillary filter, across the membrane wall and out of the capillary filter. The flow of backflush liquid dislodges the residue on the surface of the capillary filter and thus renews the efficiency of the capillary filter.

However, backflushing does not remove all residue. Sometimes, stubborn spots of residue remain on the capillary filter despite the backflushing, which continue to compromise the performance of the capillary filter.

Therefore, it is desirable to provide a device or method that could more efficiently rejuvenate or renew the performance of capillary filters.

### SUMMARY OF THE INVENTION

In a first aspect, the present invention provides a method of dislodging accumulated particles on at least one surface within a tank of liquid comprising the step of introducing a gas into the tank, such that the liquid is agitated by the gas, consequently abrading the particles on the surface, and dislodging said particles.

Accordingly, the invention offers advantages in terms of effective renewal of capillary filter, providing improved quantity of filtered liquid and less down time for chemical cleaning. This results in lower cost of treatment per unit of liquid.

In a second aspect, the invention provides a filter apparatus comprising a tank for containing a liquid; a gas introduction assembly for introducing a gas into the tank so as to agitates the liquid in the tank; whereby the agitated liquid abrades particles accumulated on at least one surface in the tank for dislodging said particles.

### BRIEF DESCRIPTION OF DRAWINGS

It will be convenient to further describe the present invention with respect to the accompanying drawings that illustrate possible arrangements of the invention. Other arrangements of the invention are possible and consequently the particularity of the accompanying drawings is not to be understood as superseding the generality of the preceding description of the invention.

FIG. 1 is a cross-sectional elevation of a first tank according to one embodiment of the present invention;

FIG. 2 is an isometric view of a base of the tank of FIG. 1;

FIGS. 2a is a schematic diagram of the flow of liquid in filtration, across the membrane of a capillary filter employed in the embodiment of FIG. 1;

FIGS. 2b is a schematic diagram of the reverse flow, which is a backflush of liquid, across the membrane of a capillary filter employed in the embodiment of FIG. 1;

FIG. 3 is a schematic diagram of a process according to an embodiment of the present invention, and;

FIG. 4 is a schematic diagram of a process according to a further embodiment of the present invention.

### DESCRIPTION OF PREFERRED EMBODIMENT

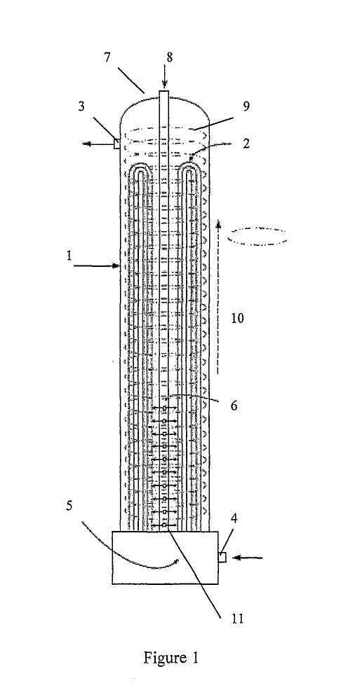

FIG. 1 shows an embodiment of the invention comprising an elongate tank 1, the tank 1 containing a plurality of capillary filters 2 each bent to form an inverted U-shape. The two ends of each inverted U-shape capillary filter 2 is embedded into the base 5 of the tank 1. Therefore, when the tank 1 is filled with liquid to be filtered, the liquid is unable to leak into the hollow channel in the capillary filter 2 through the open ends of the capillary filter 2. The liquid may only enter into the capillary filter 2 by permeating across the membrane wall of the capillary filter 2, while the residue is accumulated on the outer surface of the capillary filter within the elongated tank. The U-shape arrangement allows a free passage for the dislodged residue within the capillary filters to exit the elongated tank through the outlet port (3).

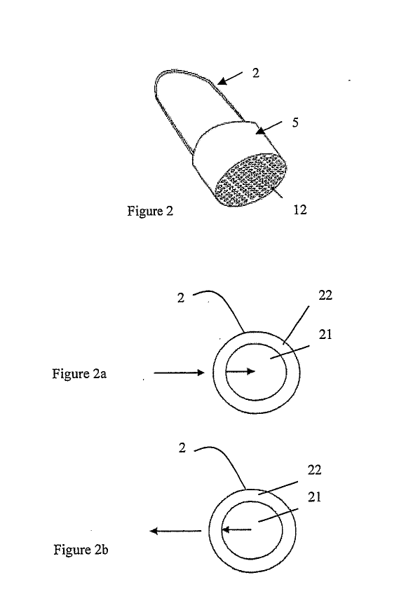

FIG. 2 is a close-up illustration of one strand of the capillary filters of FIG. 1, showing more clearly that the two ends of the capillary filter 2 are inserted into the base 5 of the tank 1. The base 5 has a plurality of holes for receiving the ends of the capillary filter 2, such that liquid permeating into the capillary filter 2 flows along the hollow channel in the capillary filter 2 and through the holes in the base 5 to be released through the bottom opening 4 of the tank 1.

Therefore, during a filtration operation, a liquid is pumped into the tank 1 though a top opening 3 (in a direction reversed of the arrow shown pointing away from the top opening 3) of the tank. The pumping pressures the liquid in the tank 1 to permeate into the capillary filters 2. The liquid thus filtered is directed by the capillary filters 2 towards the base 5 of the tank 1 and out through the bottom opening 4 of the tank 1 (in a flow direction reversed of the arrow shown pointing into the bottom opening 4).

The arrows in FIG. 2a illustrate the flow of the afore-mentioned permeation of the liquid through the membrane wall 22 of a strand of capillary filter 2 and into the hollow channel 21 in the capillary filter 2.

Unwanted particles carried by the liquid into the tank 1 are unable to permeate the membrane and thus remain in the tank 1, outside the capillary filters 2. Eventually, some of these particles are deposited and lodged onto the surface of the capillary filters 2 due to the flow of the liquid into the capillary filters 2.

The tank 1 of FIG. 1 also comprises means for introducing a gas into the tank 1. In this embodiment, the means for introducing a gas is in the form of a rod 6 erected in the radial centre of the tank 1. The top end of the rod 6 extends to the top 7 of the tank and is connected to an external gas source (not shown). The rod 6 has a plurality of holes or perforations 11 along its length, such that a gas may be introduced through the top of the rod 6, illustrated by the arrow labelled 8, and released into the tank 1 through the perforations 11. In FIG. 1, the perforations 11 are shown located at the lower half of the rod 6. However, in other possible embodiments, the perforations may be located along the entire length of the rod 6. In yet another embodiment, only one or a few perforations or other types of opening may be provided at the base of the rod 6.

Alternatively, other suitable means introduction of a gas into the tank may be used, such as a valve, a tap, or other methods known in the art, preferably, but not essentially, in a manner so as to distribute the gas broadly throughout the tank 1. An example of the gas is air or oxygen.

When the capillary filters 2 are used so much that particles that may have accumulated on the external surface of the capillary filters 2 compromise the efficiency of the filtration operation, a rejuvenation process is applied to dislodge the particles.

The tank 1 maintains some amount of liquid for the rejuvenation process and a gas is introduced into the rod 6 as indicated by the arrow labelled 8, which is released into the liquid through the perforations 11 on the rod 6. The gas forms bubbles in the liquid that rise and agitate the liquid, which abrades the particle covered surface of capillary filters 2 to mechanically loosens and dislodges the particles accumulated on the capillary filters 2. The mechanical agitation also improves dispersion and suspension of the particles in the liquid.

The gas is bubbled into the tank 1 for a predetermined period, after which a backflush liquid is applied to the capillary filters 2, concurrently with the introduction of the gas, to further dislodge the external surface of the capillary filters 2 of accumulated particles.

The backflush liquid is pumped into the bottom opening 4 (in the direction of the arrow shown near the bottom opening 4) under pressure so as to flow through the base 5 into the ends of the capillary filters 2 located within in the base 5. The backflush liquid then flows in the hollow channel 22 in each capillary filters 2 and, eventually, permeates through the membrane wall of the capillary filter 2 into the tank 1, out of the capillary filter 2.

The arrows of FIG. 2a illustrate the flow of backflush liquid from within the hollow channel 21, across the membrane wall 22 and out of a capillary filter 2.

As the backflush liquid accumulates in the tank 1, the level of liquid rises and reaches the top opening 3, which was used to introduce liquid during the afore-mentioned filtration operation. The eventual overflow of liquid is released through the top opening 3, in the direction illustrated by the arrow pointing away from the opening 3. Alternatively, instead of the top opening 3, the overflow of backflush liquid may be released through another opening of the tank 1 dedicated to expelling backflush liquid (not illustrated).

Optionally, backflush liquid may be of the same type as the liquid filtered or may be of another type, as long as the liquid is suitable for dislodging residue from the capillary filters 2. For example, chlorinated water may be used, which could provide an oxidising effect on some residue.

Thus, while the gas bubbles dislodge particles on the capillary filters 2 by agitating the liquid about the surfaces of the plurality of capillary filters 2, the backflush liquid removes the particles by an ‘in-to-out’ flow of liquid across the membrane walls, out of the capillary filters 2.

Other than dislodging stubborn accumulation of particles on the surfaces of the capillary filters 2, the concurrent gas agitation and backflushing also improves dispersion and suspension of particles in the liquid and, thereby, improves transportation of the particles by the backflush liquid to expulsion at the top opening 3.

Preferably, the gas is introduced into the liquid such that the liquid is caused to whirl about the capillary filters 2, as indicated by the dotted lines labelled 10 in FIG. 1.

More preferably, the gas bubbles create an upward helical, or spiralling, movement of the liquid, so as to further increase contact between the liquid and the particles accumulated on the capillary filters 2. This could further improve dislodgement, dispersion and transportation of the particles.

The desired effectiveness and manner of agitation provided by the gas, such as the described helical flow or even other pattern of liquid movements, depends on parameters such as the design of the rod 6, the size and type of perforations, the rate and pressure in which the gas is introduced into the tank 1, the size of the tank 1 etc., all of which would be clear to a man skilled in the art on disclosure of the invention and do not need to be discussed here. This said, it may be particularly advantageous to introduce the gas in a pulsating manner, for the “impact load” it may provide, beneficial vibration effects and other benefits that would be clear to the skilled worker. Accordingly, air scouring is performed before and during the backflushing flow. Air is injected through port (8) to provide the scouring effect on the capillary filters within the elongated tank, thereby dislodging all accumulated residue within the elongated tank. One such method involves an ON and OFF cycle of 0.5-2.0 seconds and 2.0-5.0 seconds, thereby enhancing the effectiveness of dislodging the residue within the elongated tank.

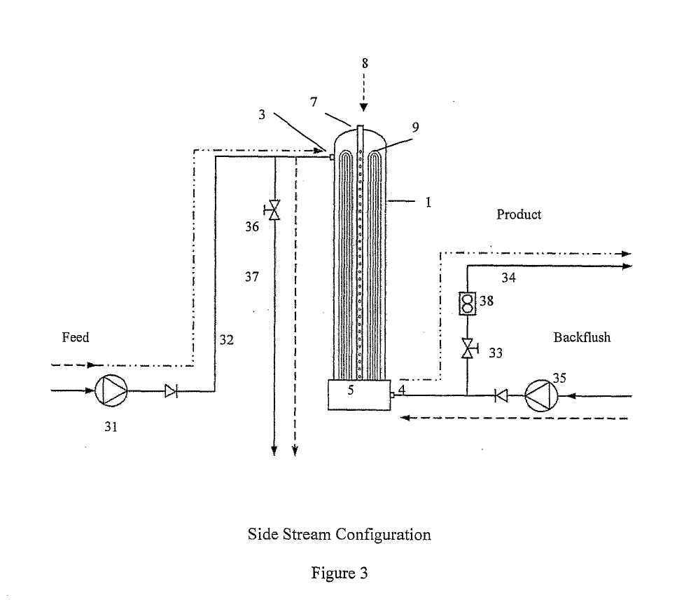

FIG. 3 illustrates a filtration system incorporating the embodiment of FIG. 1, in which the dash-and-dot lines illustrate the flow of liquid during the filtration process and the dashed lines illustrate the flow of liquid during the backflush process. The solid lines illustrate the physical piping of the illustrated system.

The system has a filtration process flow path, comprising a filtration-pump 31, an upstream-filtration-pipe 32 leading to the top opening 3 of the tank 1, a downstream-filtration-pipe 34 connected to the bottom opening 4 of the tank 1 for directing filter liquid to a collection point (not shown). A downstream-filtration-valve 33 is fitted along the downstream-filtration-pipe 34 to open and close the downstream-filtration-pipe 34. A product flow meter 38 is also fitted to the downstream-filtration-pipe 34 to monitor the amount of filtered liquid.

The system also has a backflush process flow path, comprising a backflush pump 35 connected to supply a backflush liquid into the bottom opening of the tank 1 and a downstream-backflush-pipe 37 for directing backflush liquid carrying dislodged particles away for disposal. A downstream-backflush-valve 36 is fitted to the downstream-backflush-pipe 37.

During the filtration process, the filtration-pump 31 is in operation and the downstream-filtration-valve 33 is open, while the backflush pump 34 is stopped and the downstream-backflush-valve 36 is closed.

Conversely, when the filtration process is not in operation and during the backflush process, the filtration-pump 31 is stopped and the downstream-filtration-valve 33 is closed, while the backflush pump 34 is in operation and the downstream-backflush-valve 36 is open.

Therefore, during the filtration process illustrated by the dash-and-dot lines, a filtration-pump 31 pumps a liquid to be filtered through the upstream-filtration-pipe 32 into the tank 1. The forward pressure applied by the filtration-pump 31 eventually causes a pressure to build up in the tank 1, which pressures the liquid in the tank 1 to permeate into the capillary filters 2 and out through the bottom opening 4. The downstream-filtration-valve 33 in a downstream-filtration-pipe 34 is open to allow the filtered liquid to be directed to a collection point (not shown).

When the filtration process is completed and rejuvenation of the capillary filter is required, the flow of filtration liquid as shown by the dash-and-dot lines, is stopped.

A supply of gas is then introduced via the rod 6 into the liquid remaining in tank 1 to create the agitating bubbles, as previously mentioned.

The gas is supplied for a pre-determined period before the afore-mentioned backflush process is applied, so that the agitation of liquid in the tank may loosen and/or suspend some of the particles in advance, which may save some of the backflush liquid and energy for cost concerns and increase recovery rate (product percentage of feed volume).

Subsequently, when the backflush process is applied, as illustrated by the dashed lines in FIG. 3, the filtration-pump 31 is suspended in operation to preventing liquid flow in the upstream-filtration-pipe 32. The downstream-filtration-valve 33 is also closed. The backflush pump 34 then pumps a supply of backflush liquid into the bottom opening 4 of the tank. The backflush liquid thus flows though the holes in the base 5 of the tank 1, into the hollow channels in the capillary filters 2 and permeates through the membrane walls of the capillary filters 2 into the tank 1, out of the capillary filters 2.

When resultant rising level of backflush liquid in the tank 1 reaches the top opening 3, overflow of the backflush liquid is released though the top opening 3. The downstream-backflush-valve 36 is open to allow the backflush liquid to flow through a downstream-backflush-pipe 37, carrying particles dislodged from the capillary filters 2 for disposal.

Although the embodiment is illustrated in FIG. 3 as part of a larger filtration system, it is also possible that the embodiment is a stand-along capillary filter rejuvenating apparatus. That is, capillary filters may be removed from a larger filter system and placed in a smaller, or transportable stand-alone apparatus just for rejuvenating or renewing capillary filters.

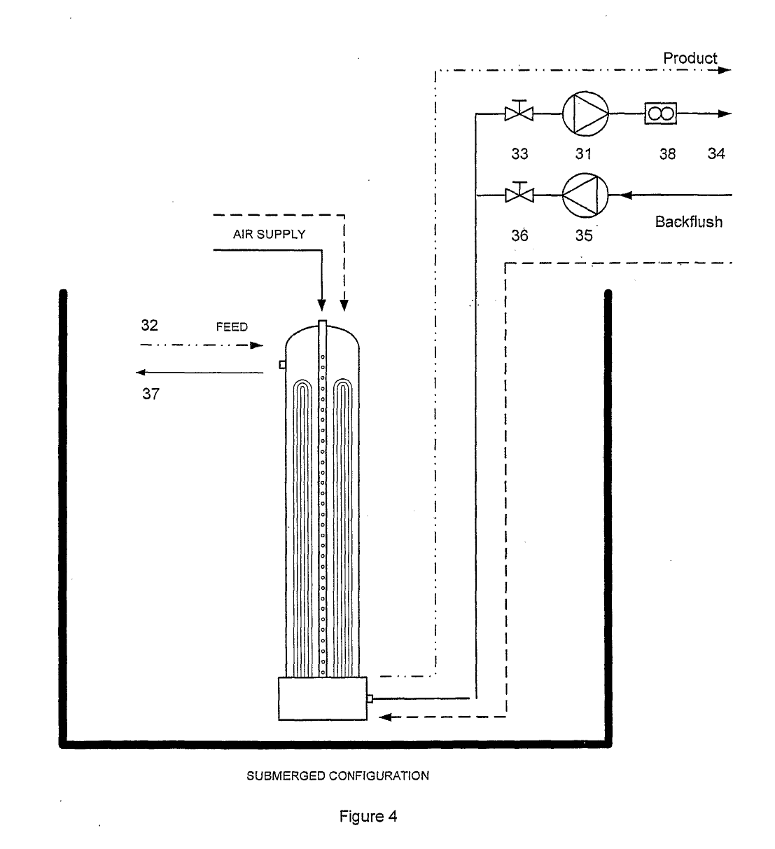

In a further embodiment, FIG. 4 provides an alternative arrangement of the invention wherein the downstream-filtration-pipe 34 further includes a filtration pump 31 intermediate the downstream-filtration valve 33 and the product flow meter 38. Further the embodiment as shown in FIG. 4 shows the backflush process flow path having a conventional valve 33 replacing the non-return valve shown on the backflush process flow path of FIG. 3. This capillary filter design is therefore available in 2 types of configuration; namely side stream (FIG. 3) and submerged (FIG. 4).

1. A method of dislodging accumulated particles on at least one surface of a filter within a tank of liquid comprising the step of
a) introducing a gas into the tank, such that the liquid is agitated by the gas to create an upward helical, or spiralling movement of the liquid, consequently abrading the particles on the surface, and dislodging said particles.

2. The method as claimed in claim 1 wherein the particles are accumulated on the surface of a filter.

3. The method as claimed in claim 2 wherein the filter is a capillary filter.

4. The method as claimed in claim 3 further comprising the steps of
b) backflushing liquid from inside the capillary filter and across a membrane of the capillary filter, such that residue on the capillary filter is dislodged; and
c) expelling liquid from the tank through an opening in the tank.

5. The method as claimed in claim 4 wherein steps a), b) and c) are concurrently executed.

6. The method as claimed in claim 2 wherein the gas causes the liquid to whirl around the filter.

7. The method as claimed in claim 4 wherein the liquid spirals upwardly in the tank to be expelled in step c).

8. The method as claimed in claim 1, wherein the introducing the gas step comprises the step of pulsating the gas.

9. The method as claimed in claim 8, wherein the pulsating step comprises cycling the gas ON and OFF.

10. The method as claimed in claim 9, wherein timing of each cycle within the cycling step is in the range of 0.5 to 2.0 seconds for ON and 2 to 5 seconds for OFF.

11. A filter apparatus comprising
a tank for containing a liquid and housing a filter;
a gas introduction assembly for introducing a gas into the tank so as to agitate and create an upward helical, or spiralling movement of the liquid in the tank;
whereby
the agitated liquid abrades particles accumulated on at least one surface of the filter in the tank for dislodging said particles.

12. (canceled)

13. The filter apparatus as claimed in claim 11 wherein the filter is a capillary filter.

14. The filter apparatus as claimed in claim 11 wherein the gas introduction assembly comprises is a rod in the tank.

15. The filter apparatus as claimed in claim 14 wherein the rod is erected in the axial centre of the tank.

16. The filter apparatus as claimed in claim 14 wherein the rod has one or more perforations for passing the gas into the tank; the perforations being on half of the length of the rod.

17. The filter apparatus as claimed in claim 16 wherein the half of the rod having one or more perforations is nearer the bottom of the tank than the other half of the rod.

18. The filter apparatus as claimed in claim 11 further comprising
a backflushing means for introducing a backflushing liquid into the tank; whereby
particles accumulated on the at least one surface of the filter in the tank is further dislodged.

19. The filter apparatus as claimed in claim 18 wherein
the backflushing liquid is introduced from the inside of a capillary filter, through a membrane wall of the capillary filter and into the tank.

20. The filter apparatus as claimed in claim 18 capable of introducing the gas at the same time as introducing the backflushing liquid.

21. The filter apparatus as claimed in claim 11, wherein the gas introduction assembly is adapted to introduce the gas in a pulsating manner.
